(19) United States
(12) Patent Application Publication
(10) Pub. No.: US 2005/0174478 A1
(43) Pub. Date: Aug. 11, 2005

(54) High speed spherical monitor for enhancing the brightness and clarity at night

(76) Inventor: Ming-Cun Chen, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/773,400

(22) Filed: Feb. 9, 2004

(51) Int. Cl. H04N 5/225

(52) U.S. Cl. 348/375

(57) ABSTRACT

The high speed spherical monitor for enhancing the brightness and clarity at night comprising a first and second driving means placed the outside of the housing. The first and second driving means could directly drive the housing to generate the axial movement or radial spin to make the monitor monitoring any angle. And the present invention discloses an annular I.R. depositing the front of the lens which closes to the inside surface of the second cover that not only enhances the brightness and clarity but also avoids the expose to having an effect that could monitor any angle and all day.

### BACKGROUND OF THE INVENTION

1. Field of the Invention

The present invention relates to a monitor, more particularly to a high speed spherical monitor which enhances the brightness and clarity of the monitor at night.

2. Description of the Related Art

Refer to FIG. 1, the conventional high speed spherical monitor comprises a semicircle housing 10 which deposits a monitor 11 in it. So, the monitor 11 in the housing 10 could inspect to outside through a transparent means 100 of the housing 11 and electrically connects to a monitor in house for monitoring. The monitor 11 is moved by a motor 12 to radially drive a turntable 13 spun. The operator controls the motor 12 to driving the turntable 13, moving the monitor 11, generating 360 degree radial spin and the motor 14 to drive the turntable 13, moving the monitor 11, generating no over 90 degree axial movement for making the monitor 11 to inspect by using the transparent means 11.

The conventional high speed monitor 1 comprises the monitor 11 and motors 12, 14 placed in the housing 10. The efficacy on the housing 10 just protects the monitor 11 for waterproof and dustproof to make it work. The disadvantage of the conventional monitor 1 could not monitor at night or almost lightless situation.

The conventional monitor 1 tries to add an annular I.R. (Infrared Rays) at the front of the lens 110 to enhance the effect of monitor 11 at night, but the monitor 11 could not drive to move the axial movement or radial spin which is limited by the space of the housing 10 and the size of the annular I.R.

The other disadvantage of the conventional monitor 1 comprises the annular I.R. in the housing 10 to make the lens 110 that could not close the inside surface of the transparent means 100 resulted in the light of the I.R. generating refracting from the transparent means 100 to the lens 110 to make expose.

So far, the monitor has a function of monitoring at night which includes the annular I.R., and the type of the monitor must belong to fastening monitor. The fastening monitor could not be moved by the motor driving spin or movement and must be moved by human. This type of the monitor isn't belong high speed monitor.

### SUMMARY OF THE INVENTION

Therefore, an object of the present invention is to provide a high speed spherical monitor for enhancing the brightness and clarity at night which could monitor at night and avoid the expose and enhance the brightness and clarity at night.

According to this invention, the present invention discloses a high speed spherical monitor for enhancing the brightness and clarity at night comprising a first and second driving means placed the outside of the housing. The first and second driving means could directly drive the housing to generate the axial movement or radial spin to make the monitor monitoring any angle. And the present invention discloses an annular IR depositing the front of the lens which closes to the inside surface of the second cover that not only enhances the brightness and clarity but also avoids the expose to having an effect that could monitor any angle and all day.

### BRIEF DESCRIPTION OF THE DRAWINGS

Other features and advantages of the present invention will become apparent in the following detailed description of the preferred embodiments of the present invention, with reference to the accompanying drawings, in which:

FIG. 1 is an schematic view showing the high speed spherical monitor of the prior art;

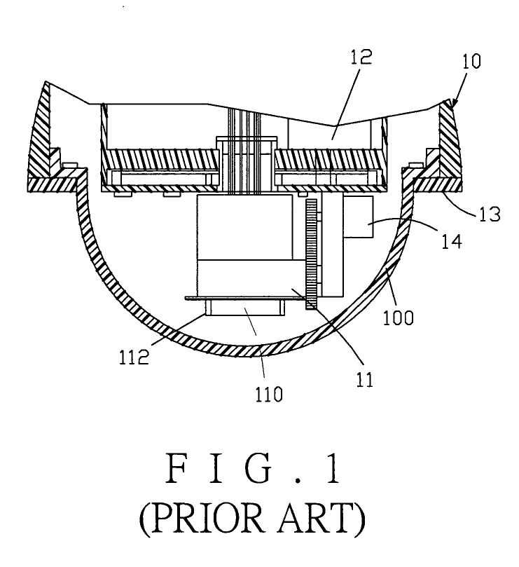

FIG. 2 is an exploded, perspective view of the high speed spherical monitor of the present invention;

FIG. 3 is a perspective view illustrating the assembly of the high speed spherical monitor of the present invention;

FIG. 4 is a schematic view showing the first driving means of the present invention;

FIG. 5 is a schematic view showing the second driving means of the present invention; and

FIG. 6 is a schematic view showing the motion of the housing of the high speed spherical monitor of the present invention.

### DETAILED DESCRIPTION OF THE PREFERRED EMBODIMENTS

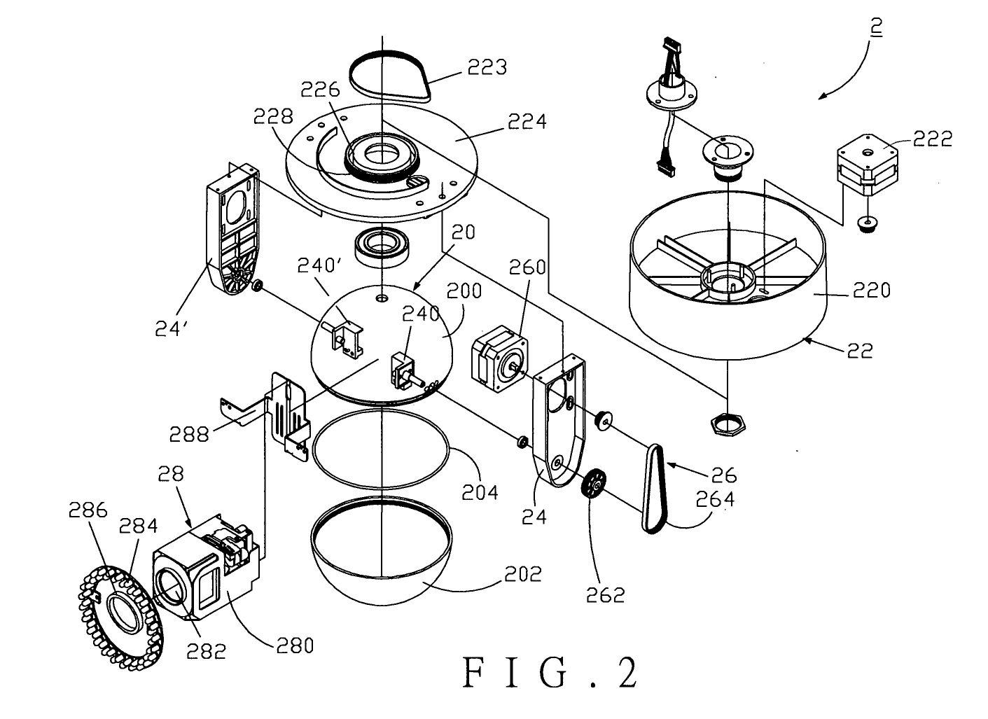

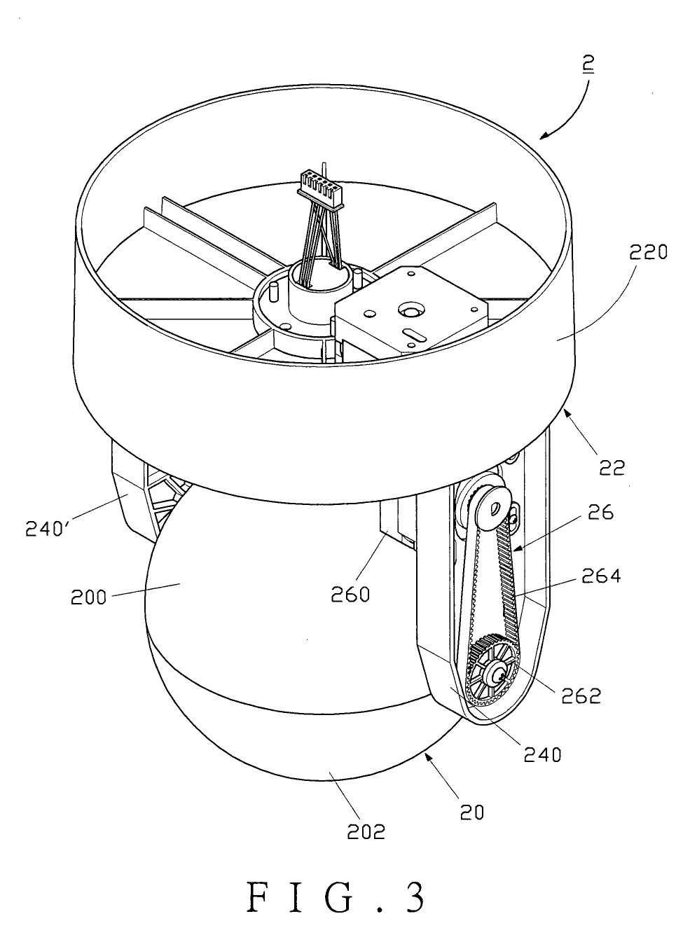

Referring to FIGS. 2 and 3, the present invention uses to ceil or install on the wall and electrically connect to a long term monitor. A high speed spherical monitor 2 for enhancing the brightness and clarity at night of the present invention comprises a housing 20, a first driving means 22, two pivotal seats 24, 24′, a second driving means 26 and a monitor 28.

The housing 20 comprises a first cover 200, being a semicircle, and a second cover 202, being a semicircle. Between them has a pad 204 to make waterproofing and assembles by a screw.

The first driving means 22 placed at the top of the housing 20 and includes a seat 220, a first motor 222 placed in the seat 220 and a turntable 224 being driven radial spin by the first motor 222. The turntable 224 has an annular wall 226 having a first gear 228 which is connected to the first motor 222 by a first belt 223. Therefore, the motor 222 drives the first belt 223 to make the first gear 228 working, and the annular wall 226 could make the turntable 224 360 degree radial spin.

Two pivotal sets 24, 24′ connect between the turntable 224 and the adaptors 240, 240′ for pivoting the outside of the housing 20.

The second driving means 26 is placed the inside of the pivotal seat 24 and comprises a second motor 260 including a second gear 262 which is opposite to the adaptor 240 of the seat 24 and a second belt 264 connecting between the second gear 262 and the second motor 260 to make the housing 20 no over 90 degree axial movement.

The monitor 28 is placed the inside of the second cover 202 and comprises a main body 280, a lens 282 placed at the front of the main body 280 and an annular I.R. 284 placed at the front of the lens 282. The sealed pad 286. And, the monitor 28 further comprises a fastening seat 288 to place it.

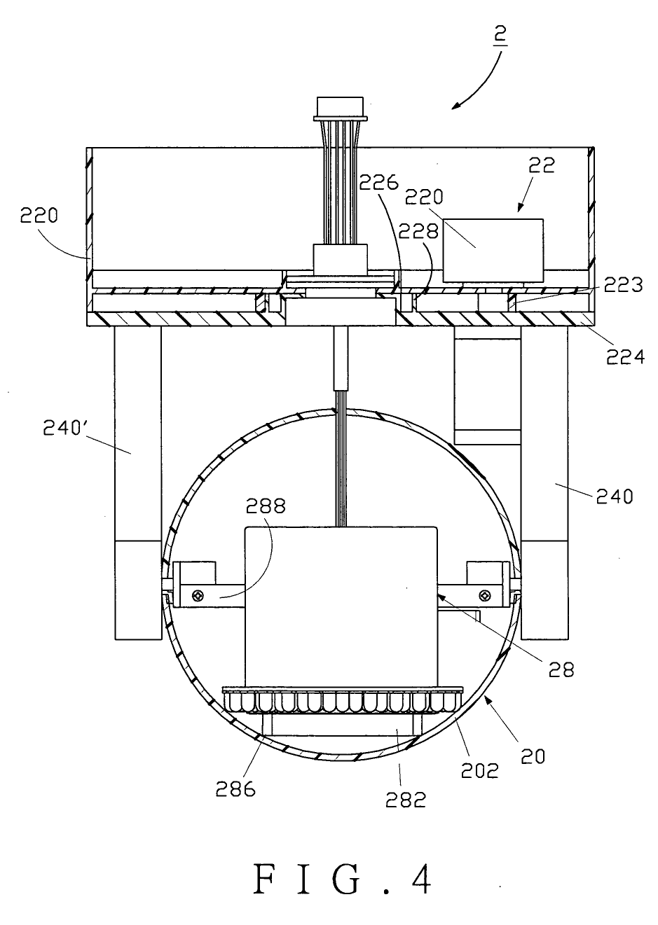

Referring to FIG. 4, the operator drives the first motor 220 which makes the belt 223 move the first gear 228, the annular wall 226 to let the turntable 224 generate 360 degree spin. And, the two pivotal seats 24, 24′ could spin 360 degree at the same time to make the monitor 28 monitor radial 360 degree.

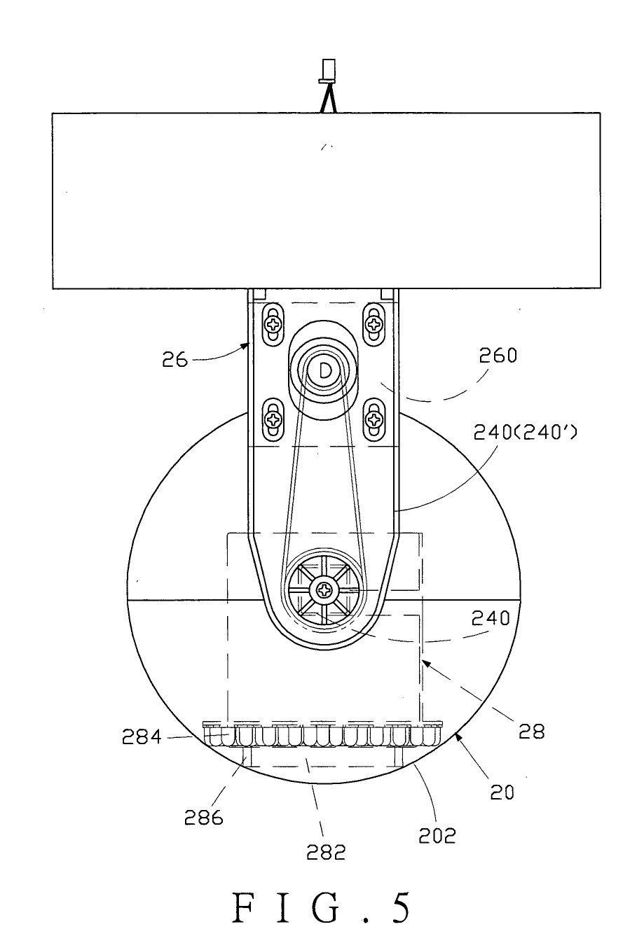

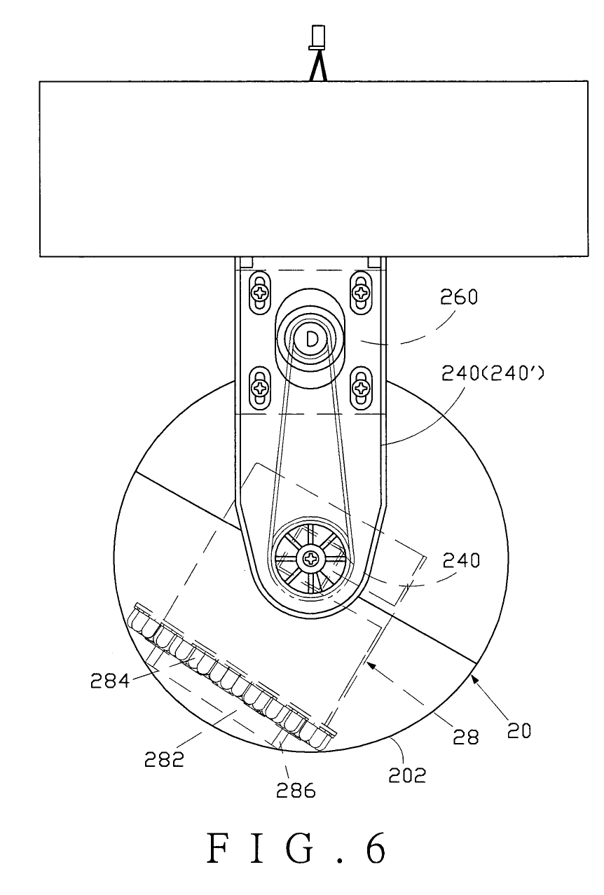

Referring to FIGS. 5 and 6, the monitor 28 makes an axial movement when the motor 260 of the second driving means 26 drives the second gear 262 and the adaptor 240 by the second belt 264 to make the housing 20 movement according to the two pivotal seats 24, 24′. So, the monitor 28 could move no over 90 degree to monitor.

The monitor 28 has a radial 360 degree or axial 90 degree monitoring effect, and does not directly drive and spins or moves with the housing 20. Further, the lens 282 of the monitor 28 closes to the inside of the second cover 202, so the housing 20 drives spin and movement and could not move the monitor 28 at the inside of the second cover 202.

Further, the lens 282 of the monitor 28 has a sealed pad 286, so the housing 20 drives spin and movement and could not move the monitor 28 at the inside of the second cover 202. And, the annular I.R. 284 of the lens 282 also dose not move for providing the effect that monitors at night and enhancing the brightness and clarity. Further, the sealed pad 286 avoids the light reflecting to the lens 282 to eliminate the expose.

The present invention discloses a high speed spherical monitor for enhancing the brightness and clarity at night comprising a first and second driving means placed the outside of the housing. The first and second driving means could directly drive the housing to generate the axial movement or radial spin to make the monitor monitoring any angle. And the present invention discloses an annular I.R. depositing the front of the lens which closes to the inside surface of the second cover that not only enhances the brightness and clarity but also avoids the expose to having an effect that could monitor any angle and whether.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

1. A high speed spherical monitor for enhancing the brightness and clarity at night comprising:
a housing having a first cover and a second cover, and the first and second covers being semicircle;
a first driving means placed at the top of the housing and including a seat, a first motor placed in the seat and a turntable in the seat to make a radial spin by the fist motor;
two pivotal seats connecting one end on the turntable and another end disposed a connection to connect on the outside of the housing;
a second driving means placing at the side of one of pivot seat and having a second motor for driving the adaptor, which being opposite to the pivot seat, to spin to make an axial movement; and
a monitor placed in the second cover and having a main body, a lens placed at the front of the main body and an annular IR placed at the front of the lens, and the lens tightly fastened at the inside surface of the second cover.

2. The high speed spherical monitor for enhancing the brightness and clarity at night as claim 1, wherein the turntable of the first driving means has an annular wall which includes a first gear connecting to the first motor by a first belt to make the annular wall a radial 360 degree spin.

3. The high speed spherical monitor for enhancing the brightness and clarity at night as claim 1, wherein the motor of the second driving means further include a second gear connecting to the adaptor, and the second motor is coupled to the second gear by a second belt to make the housing an axial 90 degree movement.

4. The high speed spherical monitor for enhancing the brightness and clarity at night as claim 1, wherein the monitor further comprises a fastening seat to place it.

5. The high speed spherical monitor for enhancing the brightness and clarity at night as claim 1, wherein at the front of the lens has a sealed pad.

6. The high speed spherical monitor for enhancing the brightness and clarity at night as claim 1, wherein between the first and second covers have a waterproof pad.

7. The high speed spherical monitor for enhancing the brightness and clarity at night as claim 1, wherein the first and second covers is assembled by a screw to form the housing.
